(19) United States
(12) Patent Application Publication
(10) Pub. No.: US 2010/0324922 A1
(43) Pub. Date: Dec. 23, 2010

(54) SYSTEM AND METHOD OF MANAGING TIME SPENT FOR HEALTHCARE

(76) Inventors: Jeffery M. Kendall, Windermere, FL (US); Chakravarthy S. Toleti, Windermere, FL (US); Rajesh S. Toleti, Windermere, FL (US); Nageshwara R. Vempaty, Saratoga, CA (US)

Correspondence Address: PAUL W. MARTIN, NCR CORPORATION, LAW DEPT., 3097 SATELLITE BLVD., 2nd FLOOR, DULUTH, GA, 30096, US

(21) Appl. No.: 12/486,139

(22) Filed: Jun. 17, 2009

(51) Int. Cl. G06Q 50/00

(52) U.S. Cl. 705/2

(57) ABSTRACT

A system and method of managing time spent for healthcare which provides patients with choices that can minimize time they spend attending to healthcare needs. The method includes establishing a record of patients which have checked-in at a healthcare facility by a server, storing times at which the patients received care from a healthcare provider by the server, storing patient wait time information by the server, and providing the patient wait time information to prospective patients through a web site by the server.

### BACKGROUND

Patients go to health care providers for treatment of health problems. Health care providers include physicians, technicians, and other healthcare personnel and the offices they work in, including offices, clinics, and hospitals. A patient visit to a provider is known as an encounter.

Patients typically check in at a reception or front desk. Patients may become dissatisfied with long lines at the front desk, especially those who are sick or uncomfortable.

Patients may also become dissatisfied with the time required to obtain healthcare. For example, the time required may include wait time to see a physician or other caregiver, starting from check-in at a healthcare facility. Time required may also include driving time to a healthcare facility.

It would be desirable to provide a system and method of managing time spent for healthcare.

### SUMMARY

A system and method of managing time spent for healthcare is provided.

The method includes establishing a record of patients which have checked-in at a healthcare facility by a server, storing times at which the patients received care from a healthcare provider by the server, storing patient wait time information by the server, and providing the patient wait time information to prospective patients through a web site by the server.

### BRIEF DESCRIPTION OF THE DRAWINGS

FIG. 1 is a block diagram of a network or computers, including a patient computer, healthcare provider computers, and a server.

### DETAILED DESCRIPTION

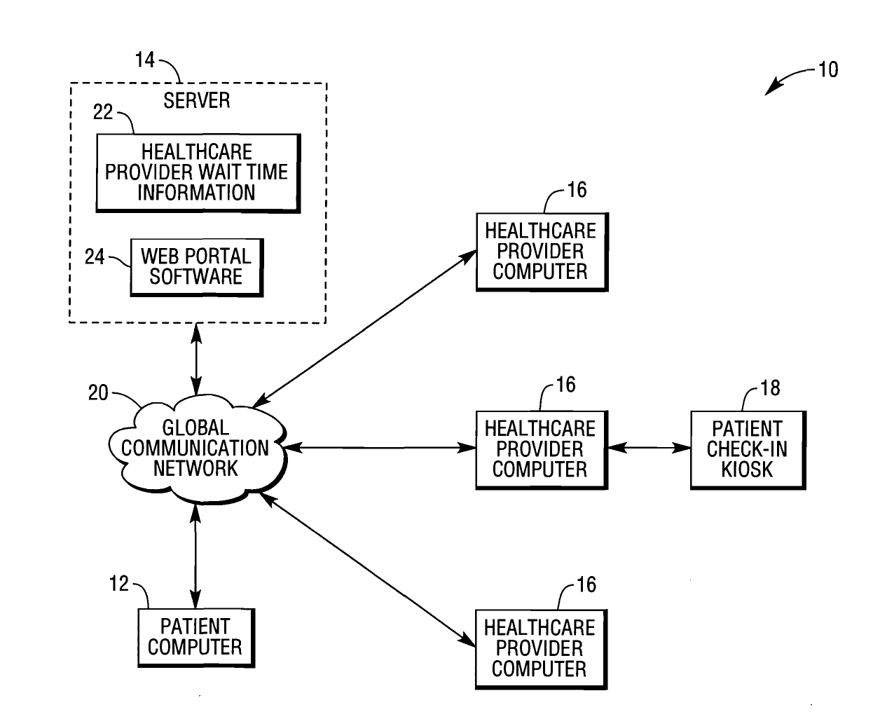

With reference to FIG. 1, an example system 10 primarily includes patient computer 12, server 14, and healthcare provider computers 16.

Patient computer 12 connects to server 14 through a global network 20, such as the Internet. Patient computer 12 may establish a connection to global communication network 20 through a gateway computer. The gateway computer may be operated, for example, by an Internet Service Provider (ISP), the patient's employer, a cellular communication provider, or a public ISP.

The connection between patient computer 12 and gateway computer may be wired or wireless. For example, patient computer 12 may connect to global communication network 20 through a wireless Internet hotspot.

Patient computer 12 may include a computer owned or used by a patient. Patient computer 12 may be located anywhere the patient is located. For example, patient computer 12 may be located at a patient's home or place of work. Patient computer 12 may be stationary or may be portable, such as a laptop computer, cellular phone, personal digital assistant, or other portable computing device capable of connecting to server 14.

Server 14 provides an estimated time to receive initial patient care based upon wait time information 22 associated with each healthcare provider to patient computer 12. Server 14 may include a web server and display the estimated time and wait time information in web pages. Patient computer 12 may execute web browser software for displaying the web pages.

Server 14 may also include web portal software 24 for establishing a web portal. As such, server 14 may store and maintain authorized user information, including user name and password information for establishing a connection between patient computer 12 and a web portal. Patients may register their information with the web portal.

Patient computer 12 may securely connect to the web portal to facilitate patient appointment scheduling and other tasks for the convenience of authorized users. Server 14 may obtain and store patient schedules from healthcare provider computers 16. In an example embodiment, server 14 may provide wait time information only to authorized web portal users.

Healthcare computers 16 are located at individual healthcare facilities, such as hospitals, clinics, physician offices, physical training offices, and other places where patients obtain care. Healthcare computers 16 may store information about patients, including patient records and patient appointment information.

Healthcare computers 16 provide information to server 14, including information entered by healthcare providers.

If server 14 is a web portal, healthcare computers 16 may provide patient records, including appointment schedules, to server 14. Healthcare computers 16 are coupled to server 14 via global communication network 20. Healthcare computers 16 may connect to global communication network 20 via gateway computers.

Some or all healthcare providers may additionally include kiosks 18 for facilitating patient check-in. Kiosks 18 are coupled to healthcare computers 16.

Wait time information is intended to convey how far behind healthcare providers are in providing care to patients on the time line. In one example embodiment, wait time information may be defined as the time period from the scheduled appointment time until receipt of initial care.

In another example embodiment, wait time information may be defined as the time between patient check-in and receipt of initial care. Other examples of wait time calculation are also envisioned.

In healthcare facilities in which care is administered in stages, wait times between stages may be tracked and entered into healthcare computers 16. For example, a first wait time may be the time period ending with receipt of first care from a nurse who takes vital signs. A second wait time may be the time period following the first time period and ending with receipt of care from a physician.

Healthcare computers 16 may calculate patient wait time information and send the patient wait time information to server 14. Healthcare computers 16 may process data manually entered by staff, such as receipt of initial care times, in addition to previously stored data, such as patient schedule information.

Alternatively, healthcare computers 16 may send data to server 14 for server 14 to calculate wait times.

Server 14 may obtain wait time information or data continuously, periodically, or upon demand. Server 14 may store most recent wait time information, for example, in a table identifying healthcare providers. The table may contain links to wait time history reports for individual healthcare providers.

Server 14 may additionally include a script or other program accessible through a web page for determining an estimated time to receipt of care based upon inclusion of a determined travel time to different healthcare providers. For example, patients may enter their current address information and server 14 may then determine a travel times and maps based upon one or more routes determined by server 14 or selected by patients. Server 14 may determine an optimal route to minimize overall patient travel time and time at a healthcare provider.

A patient at patient computer 12 may view the tables, execute the script, look at the map, and decide which healthcare provider to visit based upon any of the estimated time to receive initial care, the most recent wait times, the wait time history reports, and the travel time for each healthcare provider.

Although particular reference has been made to certain embodiments, variations and modifications are also envisioned within the spirit and scope of the following claims.

What is claimed is:

1. A method of managing time spent for healthcare comprising:
establishing a record of patients who have checked-in at a healthcare facility by a server;
storing times at which the patients received care from a healthcare provider by the server;
storing patient wait time information by the server; and
providing the patient wait time information to prospective patients through a web site by the server.

2. The method of claim 1, wherein the records include patient appointment times, and wherein the patient wait time information includes an average time period from scheduled appointment to receipt of initial healthcare.

3. The method of claim 1, wherein the records include patient check-in times, and wherein the patient wait time information includes an average time period from patient check-in to receipt of initial healthcare.

4. The method of claim 4, wherein the method further comprises:
obtaining the patient check-in times from a patient check-in kiosk by the server.

5. The method of claim 4, wherein the method further comprises:
obtaining the patient wait time information from a patient check-in kiosk by the server.

6. The method of claim 1, wherein the patient wait time information includes wait times between stages of healthcare.

7. The method of claim 1, wherein the patient wait time information includes driving time to the healthcare facility.

8. The method of claim 1, wherein the providing step includes providing the patient wait time information at the healthcare facility and at another healthcare facility to assist prospective patients in choosing either the one or the other of the healthcare facilities.

9. A method of managing time spent for healthcare comprising:
obtaining patient check-in times from patient check-in kiosks at a plurality of healthcare facilities by a server;
establishing a record of patients which have checked-in at the healthcare facilities including patient appointment times by the server;
storing patient wait time information from appointment time to receipt of initial care at the healthcare facilities by the server; and
providing the patient wait time information to prospective patients through a web site by the server to assist prospective patients in choosing one of the healthcare facilities.

10. A healthcare system comprising:
a server for obtaining patient check-in times from patient check-in kiosks at a plurality of healthcare facilities, for establishing a record of patients which have checked-in at the healthcare facilities including patient appointment times, for storing patient wait time information from appointment time to receipt of initial care at the healthcare facilities, and for providing the patient wait time information to prospective patients through a web site to assist prospective patients in choosing one of the healthcare facilities.
